(19) United States
(12) Patent Application Publication
(10) Pub. No.: US 2011/0252302 A1
(43) Pub. Date: Oct. 13, 2011

(54) FITTING NETWORK CONTENT ONTO A REDUCED-SIZE SCREEN

(75) Inventor: Mark Yalovsky, Seattle, WA (US)

(73) Assignee: Microsoft Corporation, Redmond, WA (US)

(21) Appl. No.: 12/758,719

(22) Filed: Apr. 12, 2010

(51) Int. Cl. G06F 3/14; G06F 17/00; G06F 3/041; G06F 3/048

(52) U.S. Cl. 715/234; 715/864; 715/810; 715/784; 345/173

(57) ABSTRACT

A computer-implemented method for fitting content of a network document onto a reduced-size screen comprises displaying the document on the reduced-size screen and receiving a user input to indicate a desired portion of the displayed document. In response to the user input, content is extracted from the desired portion of the document and displayed in a manner formatted to fit the reduced-size screen. An apparatus for displaying a network document in a graphical user interface for a reduced-size screen is also described.

### FIELD

The present application relates to viewing network documents (e.g., web pages), and in particular, to methods and systems for assisting users in viewing network content on a device with a reduced-size screen, such as, e.g., a mobile device screen.

### BACKGROUND

Many mobile devices, including mobile telephones, personal digital assistants and media players, are capable of connecting to the internet and displaying a wide array of web pages. Today's web pages are rich and feature with a full spectrum of content that can include, e.g., text, graphics, photographs, graphs/tables, and other types of content. These rich pages often make viewing and navigation challenging for a mobile device user who is interacting with the web page via the device's reduced-size screen. One common complaint from users is that enlarging the text of a web page to a size sufficient for reading makes reading and navigating difficult because horizontal scrolling is required. Some web sites have specific web pages for mobile device viewing with less content and features, but such specific web pages are few and some users still demand access to the normal web pages with their full content and features. There is a need to improve the mobile device user's experience in displaying and navigating normal web pages, such as in how content is selected, formatted and displayed on the reduced-size screen.

### SUMMARY

Described below are methods and systems for fitting content of a network document, typically a document using HTML, XML or another markup language and having a network address (e.g., an IP address) onto a reduced-size screen. According to one approach, a method includes displaying a web page on a reduced-size screen of a device, receiving an input from a user of the device to indicate which portion of the displayed web page is desired, and, in response to the user's input, extracting text from the desired portion of the web page and displaying this extracted text to fit the reduced-size screen.

In some embodiments, the content that is extracted from the desired portion of the web page and then fit to the reduced-size screen is text. In some embodiments, extracting text from the desired portion of the web page includes excluding or removing non-text content from the desired portion.

Receiving user input to indicate a desired portion of the displayed web page can include receiving a signal that indicates the user has contacted a touch-sensitive area of the reduced-size screen. In a first example, the location of the user's contact with the screen is used to specify the desired portion of the web page to fit to the reduced-size screen. According to a second example, the user's contact with a button or other control, which may located on the screen or in another location, specifies the desired portion of the web page, but not according to the location of the contact. As one illustration of the second example, the user's contact with a button or other control, such as a fit to screen button, can designate that the desired web page portion to be displayed will be a majority text portion of the web page.

Displaying the extracted text formatted to fit the reduced-size screen can include displaying the text wrapped to fit the reduced-size screen such that lines of text are visible without horizontal scrolling. The methods and systems described herein optionally provide for zooming of the extracted text and reformatting the zoomed text to fit the reduced-size screen, i.e., zooming can take place while remaining in a “fit to screen” mode.

These and other features of will be more readily apparent from the following detailed description, which proceeds with reference to the accompanying drawings.

### BRIEF DESCRIPTION OF THE DRAWINGS

FIG. 1 is an embodiment of a mobile device or other device with a reduced-size screen.

FIG. 2 is a schematic view of a mobile device screen that is displaying a web page having at least two different portions.

FIG. 3 is a schematic view of the mobile device screen showing the web page of FIG. 2 after a user has pressed a zoom button, the right portion of the web page which would only be visible with horizontal scrolling being shown in dashed lanes.

FIG. 4 is a schematic view of the mobile device screen showing, according to the present methods, the web page of FIG. 2 after the user has touched a portion of the web page that the user desires to view in a fit to screen mode.

FIG. 5 is a schematic view of the mobile device screen showing the text from the desired portion of FIG. 4 laid out to fit the screen without requiring horizontal scrolling.

FIG. 6 is a schematic view of the mobile device screen showing the text from FIG. 5 after the user has pressed the zoom button to further magnify the text while in the fit to screen mode.

FIG. 7 is a schematic view of a mobile device screen displaying a web page similar to FIG. 2, except the screen shows a “FIT” button that can be actuated to initiate the fit to screen mode.

FIG. 8 is a schematic view of the mobile device of FIG. 7 after the user has pressed the “FIT” button, showing a majority text portion of the web page of FIG. 7 formatted to fit the screen.

FIG. 9 is a flow chart of a method for selectively displaying a web page to fit content to a reduced-size screen.

FIG. 10 is a flow chart of a first approach to receiving user input for indicating a desired web page portion to be fit to the reduced-size screen.

FIGS. 11A, 11B, 11C and 11D are flow charts of alternative methods for identifying the text within the desired web page portion to be extracted for lay out on the reduced-size screen.

FIG. 12 is a flow chart of a second approach for receiving user input for indicating a desired web page portion.

FIGS. 13A, 13B and 13C are flow charts of alternative methods for identifying the text within the desired web page portion to be extracted for lay out, according to an alternative approach.

FIG. 14 is a diagram showing an environment in which any of the described devices and methods can be used.

### DETAILED DESCRIPTION

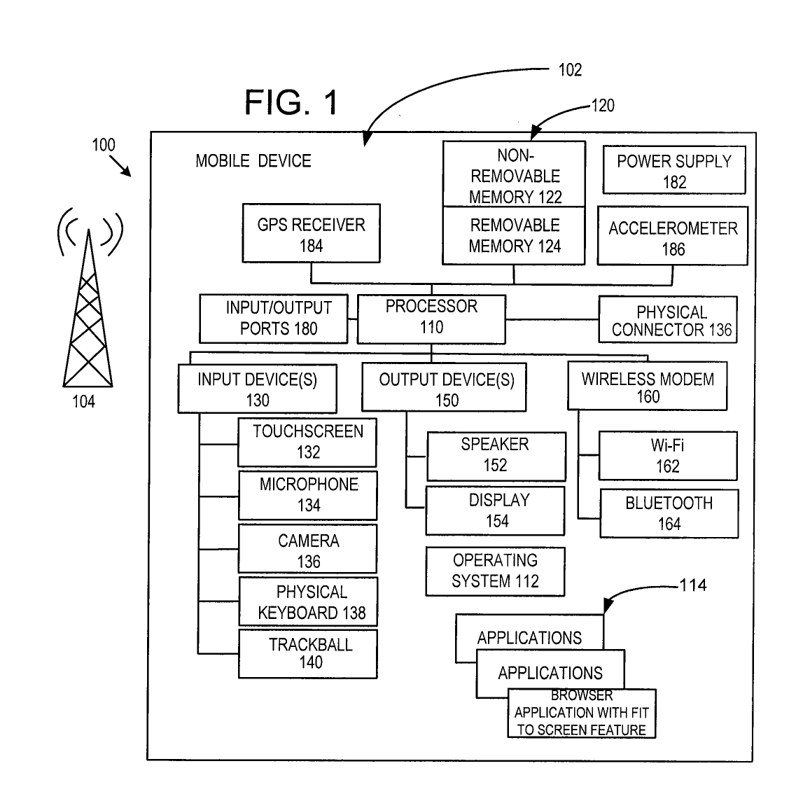

FIG. 1 is an exemplary mobile device 100 including a variety of optional hardware and software components, shown generally at 102. Any component 102 in the mobile device can communicate with any other component, although for ease of illustration, not all connections are shown. The mobile device can be any of a variety of computing devices (e.g., cell phone, handheld computer, Personal Digital Assistant (PDA), etc.), and can allow wireless two-way communications with one or more mobile communications networks 104, such as a cellular or satellite network. The illustrated mobile device can include a controller or processor 110 (e.g., signal processor, microprocessor, ASIC, or other control and processing logic circuitry) for performing such tasks as signal coding, data processing, input/output processing, power control, and/or other functions necessary for implementing the mobile device. An operating system 112 can control the allocation and usage of the components 102 and support for one or more application programs 114. The application programs typically include email applications, calendars, contact managers, web browsers, text and media messaging applications. Memory 120 can include non-removable memory 122 and/or removable memory 124. The non-removable memory 122 can include RAM, ROM, flash memory, a hard disk, or other well-known memory storage technologies and can be used for storing data and/or code for running the operating system 112 and the applications 114. Example data can include web pages, text, images, sound files, video data, or other data sets to and from one or more network servers or other mobile devices via one or more wired or wireless networks. The removable memory 124 can include flash memory or a Subscriber Identity Module (SIM) card, which is well known in GSM communication systems, or other well-known memory storage technologies, such as “smart cards.” The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device can support one or more input devices 130, such as a touch screen 132, microphone 134, camera 136, physical keyboard 138 and/or trackball 140 and one or more output devices 150, such as a speaker 152 and a display 154. Other possible output devices (not shown) can include piezoelectric or other haptic output devices. A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth or Wi-Fi). The wireless modem 160 is typically configured for communication with one or more cellular networks, such as a GSM network for data and voice communications within a single cellular network, between cellular networks, or between the mobile device and a public switched telephone network (PSSTN). The mobile device can further include at least one input/output port 180, a power supply 182, a satellite navigation system receiver 184, such as a Global Positioning System (GPS) receiver, an accelerometer 186, a transceiver 188 (for wirelessly transmitting analog or digital signals) and/or a physical connector 190, which can be a USB port, IEEE 1394 (FireWire) port, and/or RS-232 port. The illustrated components 102 are not required or all-inclusive, as any components can deleted and other components can be added.

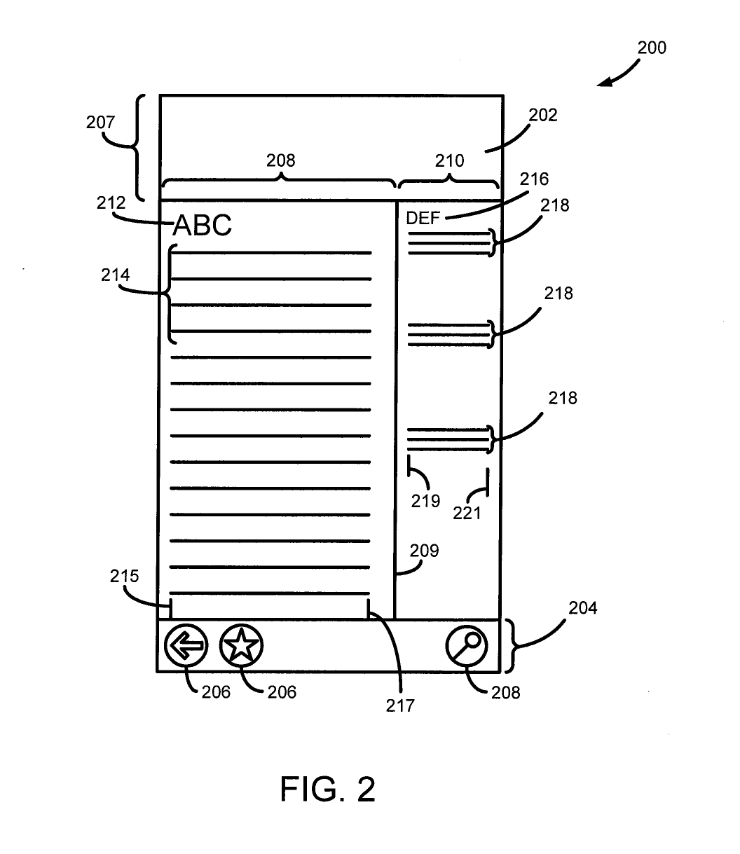

FIG. 2 is a view of a representative user interface 200, which can be implemented with the touch screen 132. As illustrated, the user interface 200 is configured to display a web page 202 and, at its bottom extent, a tool bar 204. The tool bar 204 can include one more icons 206, and, as will described below in more detail, the zoom icon 208. In a preferred embodiment, the icons are touch sensitive buttons on the user interface 200, but of course it would be possible to substitute other types of controls for executing the same operations. In the illustrated embodiment, the web page includes a top area 207, which might include a graphic or other non-text content, followed by two columns that contain text, including a wider left column 208 and a narrower right column 210. The left column 208 has a heading 212 followed lines of text 214, which are shown schematically, arranged in a long paragraph. The lines of text 214 in the left column begin at a left margin 215, which is spaced from the left side of the interface, and extend to the left column right margin 217. The right column 210 has a heading 216 followed by paragraphs 218 of text, three of which are shown in the figure. The right column 210 is separated from the left column 208 by a column separator 209, which may be visible as illustrated or invisible. The text in the paragraphs 218 begins at a right column left margin 219, which is spaced from the column separator 209, and extends to a right margin 221, which is spaced from the right side of the interface.

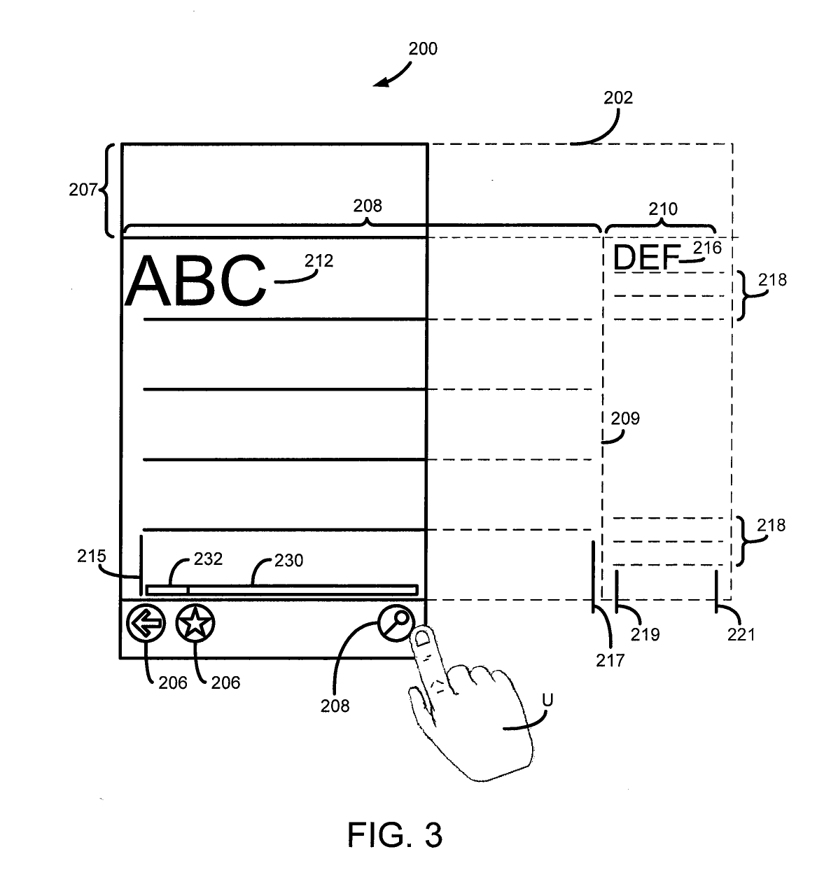

FIG. 3 is a view of the interface 200 after a user U (shown at a reduced scale for clarity) has actuated the zoom button 208 to enlarge the text on the web page 202 for easier reading, with the remainder of the web page that is larger than the screen and thus no longer visible shown in dashed lines. As can be seen in FIG. 3, a portion of the left column 208 remains visible and is presented in a magnified size, but the right margin 217 of the left column and the entire right column 210 are no longer visible within the current viewing area. The lines of text 214 continue beyond the right side of the screen, so it is necessary to scroll horizontally to read the lines of text 214 in their entirety. As is typical in many applications, a scrolling control 230, with a slider 232 allowing the right portion of the web page to be moved into view, appears when the web page exceeds the size of the screen.

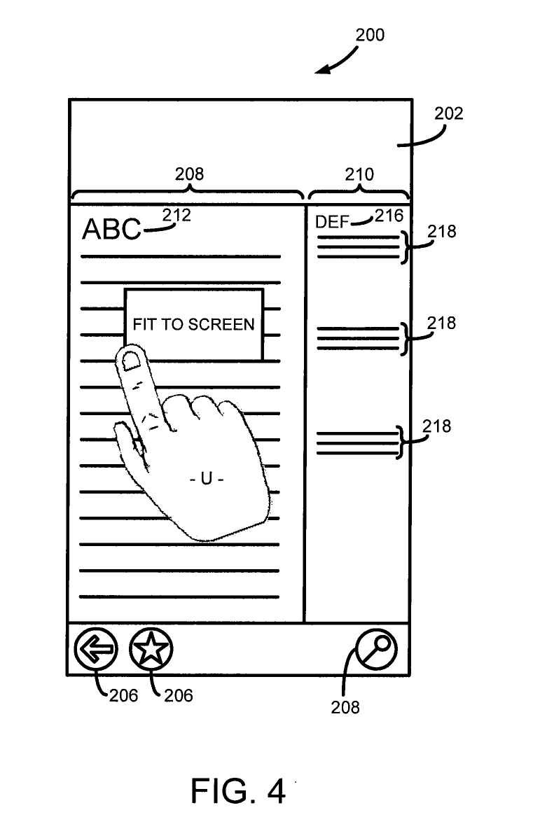

FIG. 4 is an illustration of one aspect of the present application that reduces the need to use horizontal scrolling to read text. In FIG. 4, the web site 202 is received by the device and shown on the interface 200 at its original or normal size, similar to FIG. 2. As illustrated, the user U has touched and held the screen momentarily at the location shown, i.e., within the left column 208, which is within a touch sensitive region of the screen. In turn, a message, such as, e.g., the on-screen message or menu 270, is caused to be displayed on the screen. The message “FIT TO SCREEN” informs the user that, in response to the touch and hold operation, the content in the selected portion of the web page (i.e., the left column 208, in this example) will be reformatted for display in a “fit to screen” format.

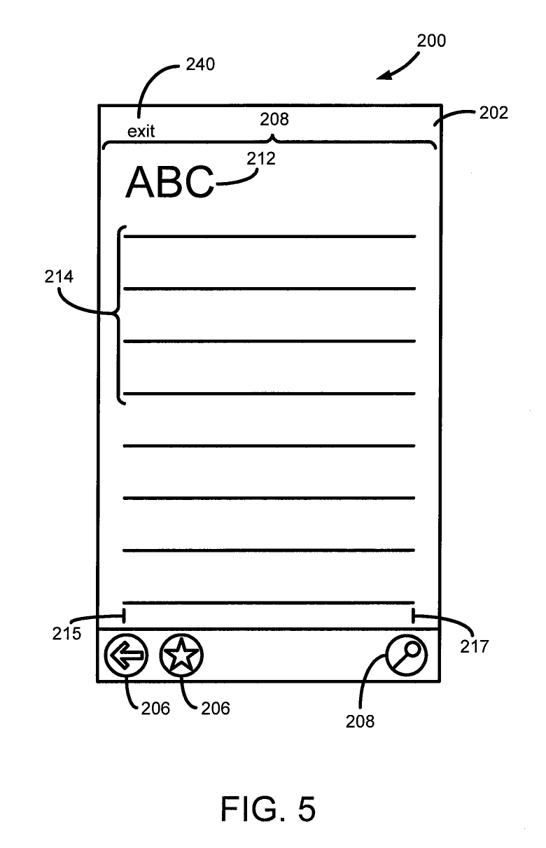

FIG. 5 is a view of the interface 200 after the selected or desired content has been automatically formatted by the device's browser and then displayed in fit to the screen mode. As illustrated, FIG. 5 shows that the left column 208 is now being displayed in fit to the screen mode. For example, in the illustrated implementation, for each of the lines of text 214 within the viewable area, the entirety of that line is visible and its margins 215, 217 are also visible. It is likely that fewer than all lines of text for the selected portion are visible at once, so the user will vertically scroll to view subsequent lines, which is a typical operation and not viewed to be as disruptive as horizontal scrolling.

Stated differently, in some embodiments, initiating fit to screen mode causes a network document scrollable in two dimensions (i.e., horizontally and vertically) to be automatically reformatted as a document scrollable in only one dimension (e.g., only vertically scrollable, at least for most applications). Text is reformatted so that the words of the text block are wrapped to fill as many lines as necessary to present every word of the selected text in a column sized for the width of the screen. The methods adjust the font size as necessary. Typically, in the case of a portion of a web page being fit to screen, the font size of the selected portion would be increased, since less of the web page is being displayed and the larger font size allows for easier reading of the selected portion.

In addition, a control is provided to exit the fit to screen mode, such as the on-screen touch sensitive “exit” button 240 or another suitable control.

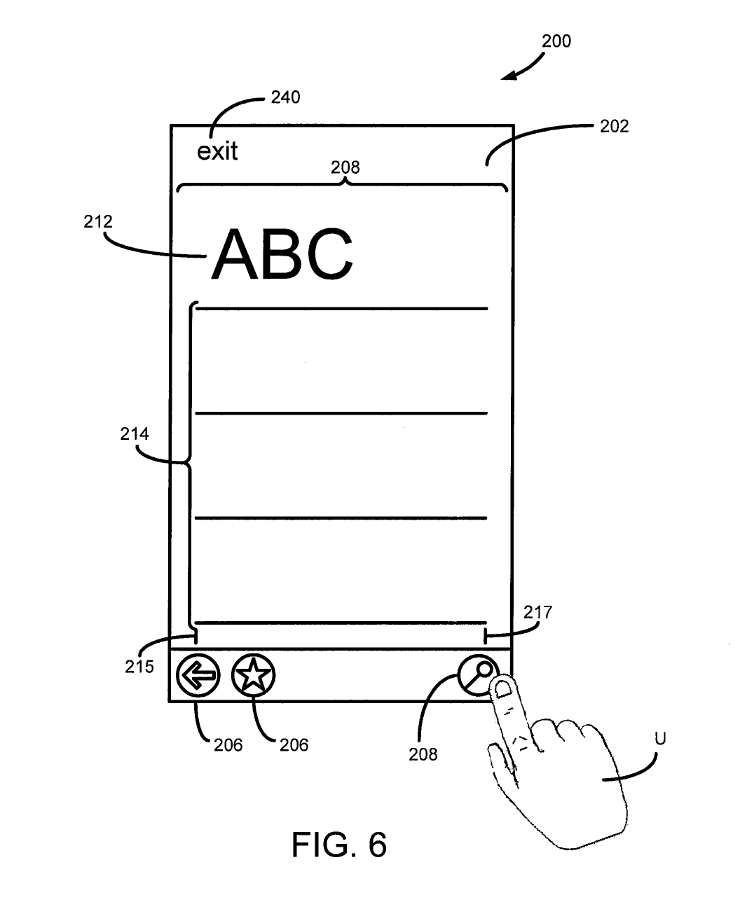

FIG. 6 is a view of the interface of FIG. 5 after the user has further zoomed the display. Since the interface is still in the fit to screen mode, the same left column 208 is magnified and reformatted to fit the screen. Thus, the lines of text 214 appear entirely within the screen, but fewer lines are visible. The user would continue to use a vertical scrolling operation to see additional text. As in FIG. 5, when the user desires to exit the fit to screen view and return to the normal view of the web site as shown in FIG. 4, the user taps and holds the exit button 240.

The FIG. 5 and FIG. 6 interfaces, which are for the fit to screen mode and the zoomed fit to screen mode, respectfully, can be implemented as overlays, such that the normal view of the web site (i.e., as shown in FIG. 4) remains in the background and becomes visible when the exit button 240 is pressed to dismiss the overlaid fit to screen view. Using overlay technology to implement the fit to screen mode can increase the speed of the operation, use less resources and provide a smoother user experience than, e.g., requiring a separate window to be opened (and closed) for each different view.

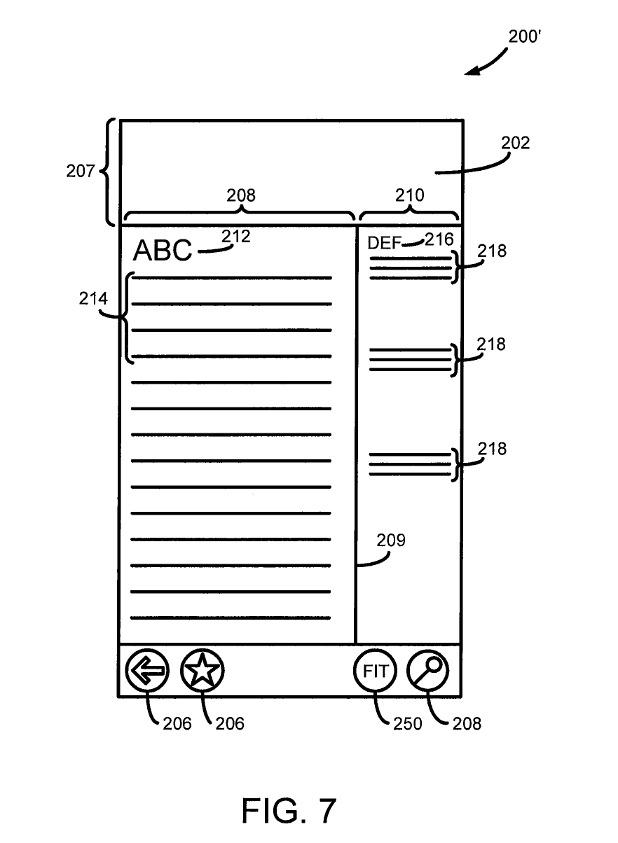

FIG. 7 is a view of a modified interface 200′ according to a second approach by which a control at a fixed location is used to switch to the fit to screen mode. In the approach of FIGS. 4-6, the location at which the screen is contacted (such as with a finger, stylus or other object) is correlated to the web page portion that the user desires to view in the full screen mode. In FIG. 7, there is a dedicated control, such as the FIT button 250 in the toolbar 203, that can be actuated to switch to the fit to screen mode. FIG. 7 shows the web site in its normal view and having at least two portions, such as the left column 208 and the right column 210.

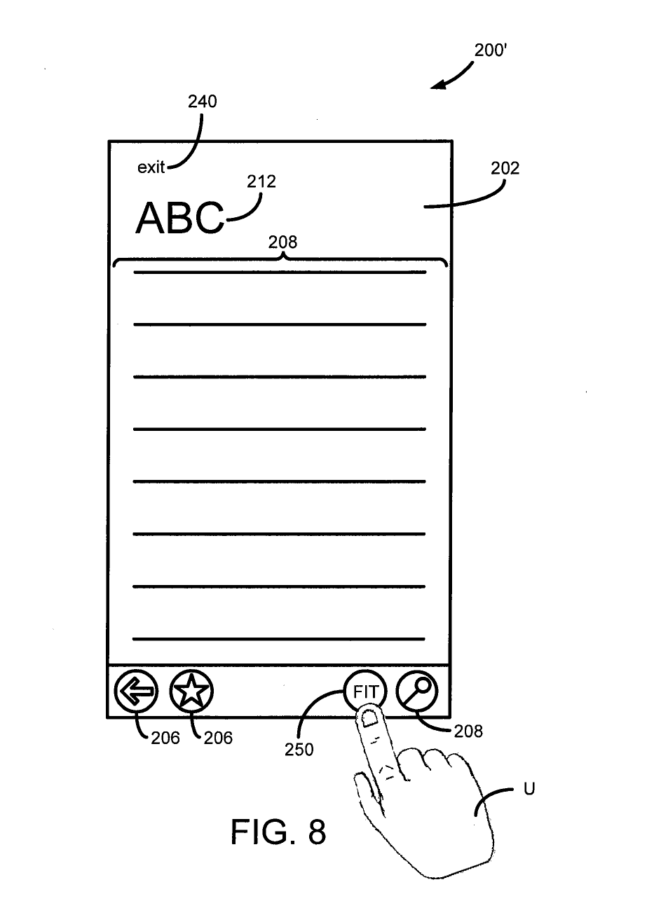

FIG. 8 is a view of the interface 200′ after the user U has pressed the FIT button 250. Pressing the FIT button 250 has triggered a process of determining a particular portion of the web page to be displayed, e.g., a majority text portion of the web page, which is discussed below in greater detail. The left column 208 has been determined to be the majority text portion of the web page, and thus as shown in FIG. 8, the left column 208 has been fit to the screen. As in the case of FIG. 5, the user can press the exit button 240 to exit the fit to screen mode, or press the zoom button 208 (see FIG. 6) to further magnify the view while remaining in the fit to screen mode.

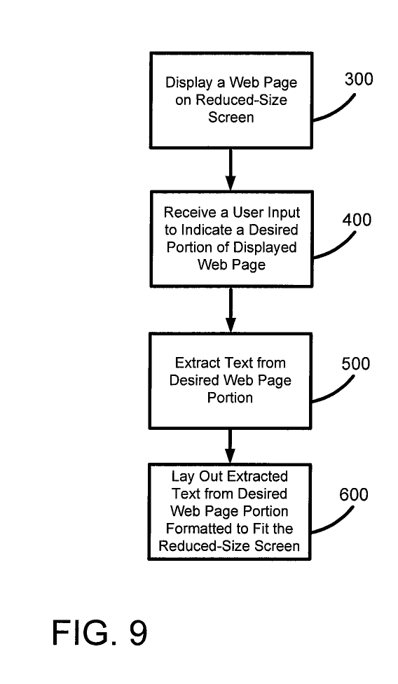

FIG. 9 is a flow chart of a method for selectively displaying a web page to fit content to a reduced-size screen. In process block 300, a web page is displayed in its normal view on a device having a reduced-size screen, such as the mobile device 100 or other similar device. For example, the user interfaces 200, 200′ of FIGS. 2 and 7, respectively, show a web page 202 displayed in its normal view.

In process block 400, input from a user viewing the web page 202 is received to indicate a desired portion of the web page that the user wishes to view in a fit to screen mode. Specifically, the user input indicates a desired portion of the web page 202 that the user desires to view in the fit to screen mode, e.g., to allow for easier reading of text. According to a first approach, the user input is an operation indicating a specific location on the web page that the user desires to view in the fit to screen mode. As one example, in the implementation shown in FIG. 4, the user indicates a location by contacting a touch sensitive screen, and the point of contact specifies the portion of the web page that the user desires to view in the fit to screen mode.

According to a second approach, the desired portion of the web page 201 that the user wishes to view in the fit to screen mode is, e.g., a majority text portion of the web page. For example, a user viewing the web page 202 in FIG. 7 may wish to see the portion of the web page with the most text in a fit to screen mode. The majority text portion may be determined by word count, character count or size in memory, or some other measure.

In process block 500, text is extracted from the desired web page portion. Thus, the text from the desired web page portion is identified. In some cases, the desired web page portion to be viewed in the fit to screen format may include other content, e.g., graphics, photos or other non-text content, in addition to text. The act of extracting text from the desired web page portion can include specifically excluding non-text content. In process block 600, the extracted text from the desired web page portion is laid out or formatted in the fit to screen view, such as is shown in the examples of FIG. 5 and FIG. 8.

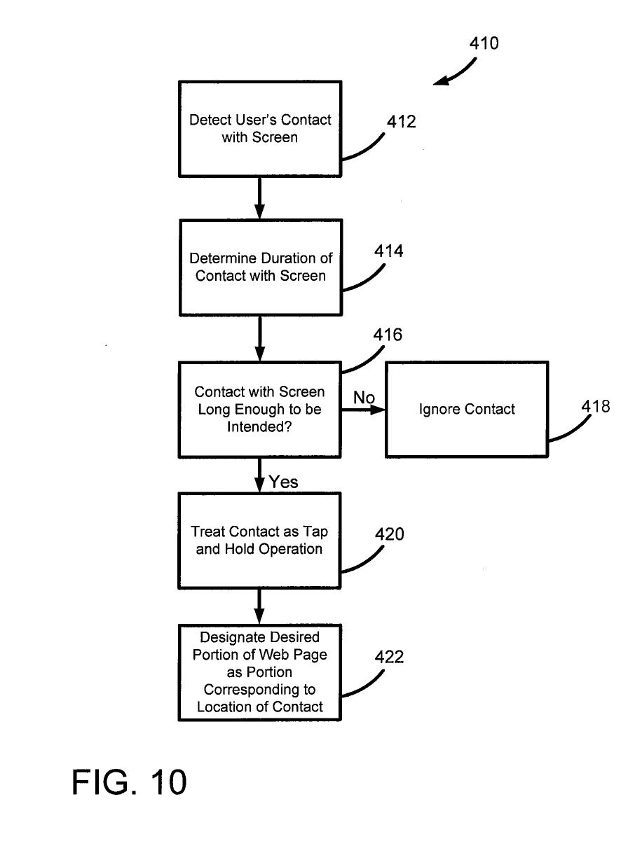

FIG. 10 is a flow chart showing a specific implementation of the first example of receiving user input according to process block 400 of FIG. 9. In FIG. 10, a process 410 is illustrated for receiving user input to indicate a desired portion of the displayed web page, which follows the first approach and provides for the user to specify a location. In process block 412, contact with the screen by the user is detected. In process block 414, the duration of the contact is determined. In process block 416, it is determined whether the contact is long enough (i.e., exceeds a predetermined timing threshold) in duration to be intended, and if so, the contact is treated as a touch and hold operation in process block 420. If the duration of the contact is too short, the contact with the screen is considered to be incidental and not intended, and thus the contact is ignored (process block 418). In process block 422, the portion of the web page that is adjacent or contains the location of the contact is designated as the desired web page portion, and the process flow returns to process block 500, i.e., extracting text from the desired web page portion.

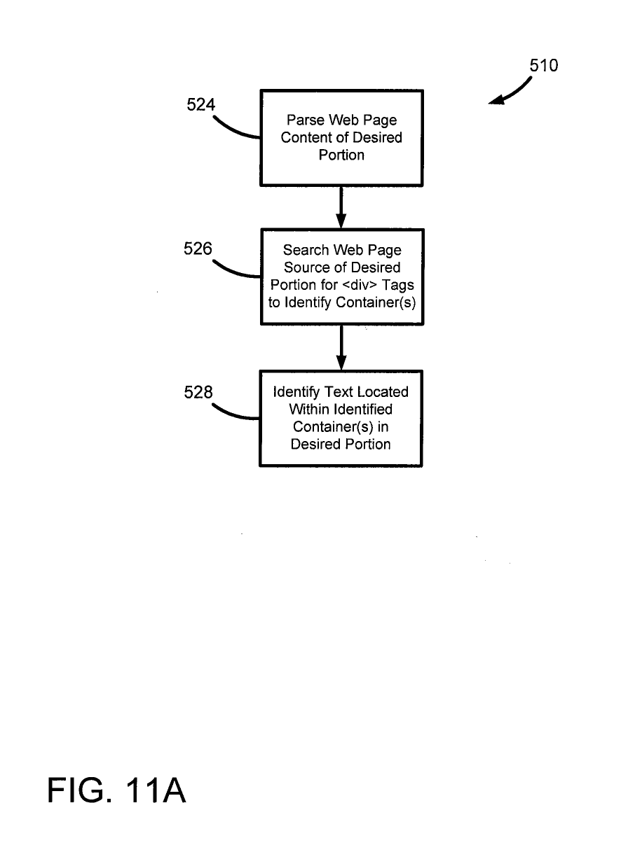

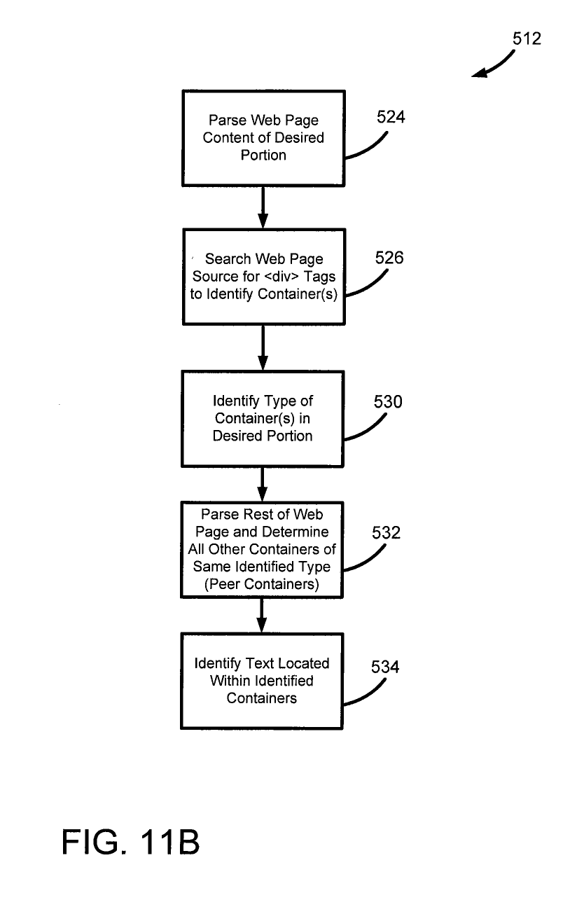

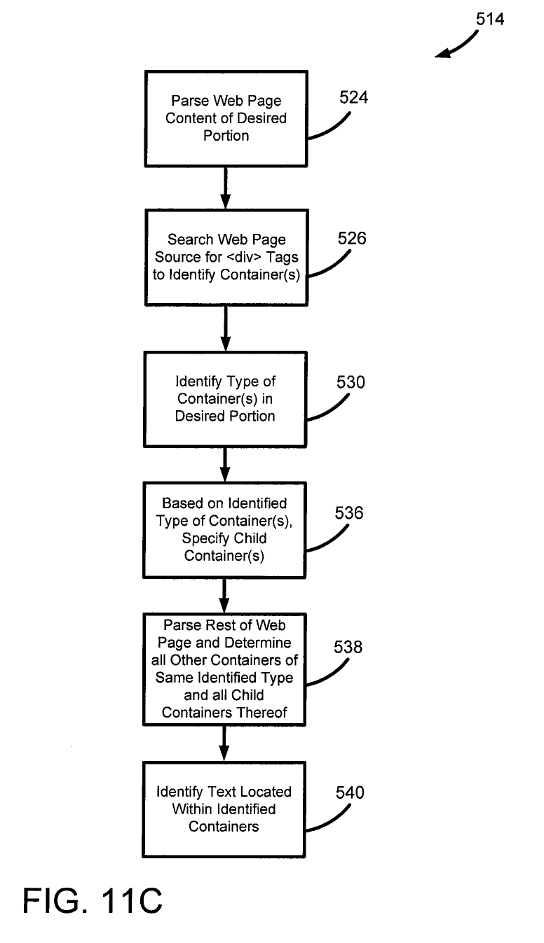

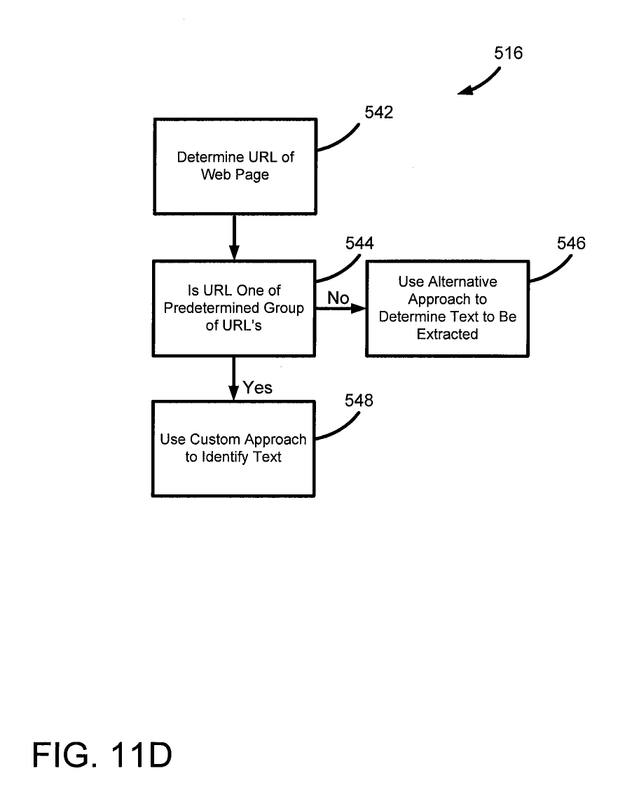

FIGS. 11A-11D are flow charts showing four different specific implementations of extracting text from the desired web page portion according to the process block 500 of FIG. 9. In general, these methods comprise searching the source of the web page for identifiers of large blocks of text. These methods could also be implemented to make use of rendered web pages instead of their sources.

Specifically, the illustrated process 510 of FIG. 11A comprises parsing the web page content of the desired portion of the web page (process block 524). In process block 526, the web page source is searched for blocks of text, e.g., by searching for HTML <div> tags that identify containers. Current HTML web page design makes use of the <div> element, which defines a division of the web page—a so-called block level “container” of the web page's structure. Specifically, a pair of <div> tags is said to define the boundaries of the container, and the contents of container may include nearly any other kind of tag, including tags identifying one or more containers nested within this container. Using containers is considered more flexible than defining tables or frames and is featured prominently in CSS HTML, which takes advantage of “cascading style sheets.” For purposes of this application, the important aspects of a container are that it can contain text, images and other types of content, parsing the web page allows for determining which containers are present and what content they contain, and the association of content with a particular container or containers allows application of general rules, e.g., in how content is to be displayed.

As is well known, longer blocks of text are presented within <p> (or “paragraph”) tags in HTML (there are also designated tags for other customary text parts of a page including, a heading, a title, a body, a sidebar, etc.) One or paragraphs set off with <p> tags could then be included with a container named “main piece.” A search of the HTML source would reveal that main piece is a container, and further that the main piece container includes paragraphs of text.

It should be noted that some web pages uses a table in which one or more cells of the table contain text delimited by <p> tags. In some embodiments, the text within cells may be processed for possible designation as a part of the desired portion, and in other embodiments text within cells of a table is excluded.

In process block 528, the text located within those identified container(s) from process block 526 is designated, and then the process flow continues to process block 600 of FIG. 9, i.e., the laying out of the extracted text from the desired web page portion in a fit to screen format.

In FIG. 11B, the illustrated process 512 includes parsing the web page content of the desired portion and searching the web page source for <div> tags to identify containers as in the process 510 of FIG. 11A (process blocks 524 and 526, respectively). In process block 530, however, a type is specified for the identified container(s), and in process block 532, i.e., the remainder of the web page is parsed and all other containers of the same type as the identified container(s) are also identified. Stated differently, in process block 532, “peers” of the identified container(s) are identified, and then the process flow continues to process block 600 of FIG. 9, i.e., the laying out of the extracted text.

In FIG. 11C, the illustrated process 514 includes parsing the web page content of the desired portion, searching the web page source for <div> tags to identify containers and identifying a type of the identified container(s) as in the process 512 of FIG. 11B (process blocks 524, 526 and 528, respectively). In process block 536, however, any other container having a child relationship with the identified container(s) is also identified. In process block 538, the remainder of the web page is parsed, and all other containers of the same type as the identified container(s), as well as all child containers thereof, are identified. Stated differently, in process block 538, all peers of the identified container(s) and all children of peers are identified. Following process block 538, the process flow continues to process block 600 of FIG. 9, i.e., the laying out of the extracted text.

In FIG. 11D, the illustrated process 516 includes applying a custom approach to identifying text if the web site is one of a predefined group of web sites. In process block 542, the identity of the web site is determined, e.g., by determining the web site's URL. In process block 544, the URL is compared to a list or table of a predefined group of web sites. If the current web site's URL is not among those identified in the group, then the process flow continues to process block 546, and another approach to determining the text to be extracted is used (for example, any of the approaches of FIG. 11A, 11B or 11C could be followed). If the current web site's URL is among those in the predefined group, then the process flow continues to process block 548 and a custom approach to determining which text to identify is followed. For example, in response to a determination that the current website is a leading news website, a user input to indicate a desire to fit text to the screen could trigger a custom approach to fit the current leading story to the screen.

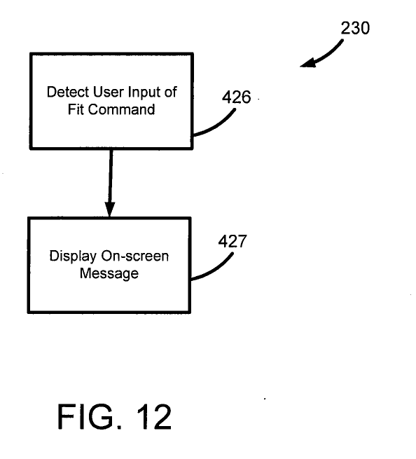

FIG. 12 is a flow chart showing an implementation 411 of receiving user input according to the second approach via a control at a fixed location. In process block 426, a user input indicating switch to fit to screen mode is detected. This user input may be made by pressing the FIT button or actuating another control at a fixed location. In process block 427, which is optional, a message is displayed on the screen. Following process block 427, the process flow then continues to process block 500.

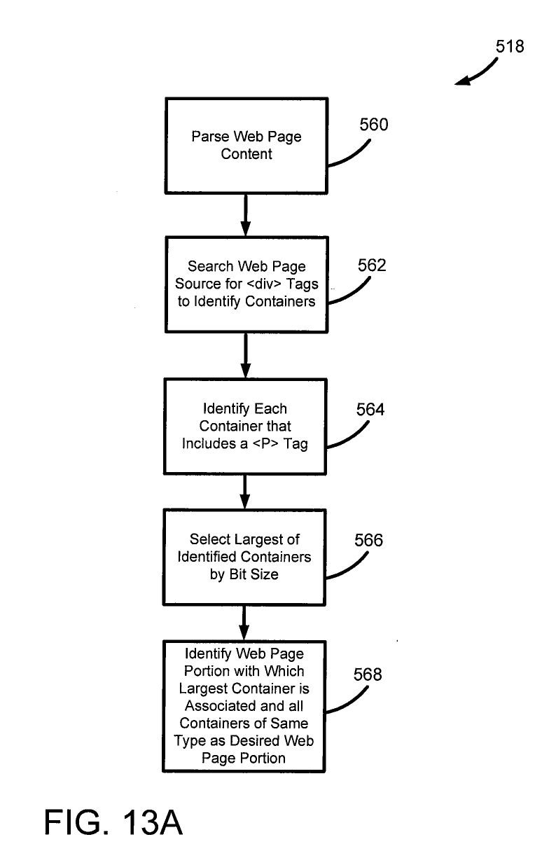

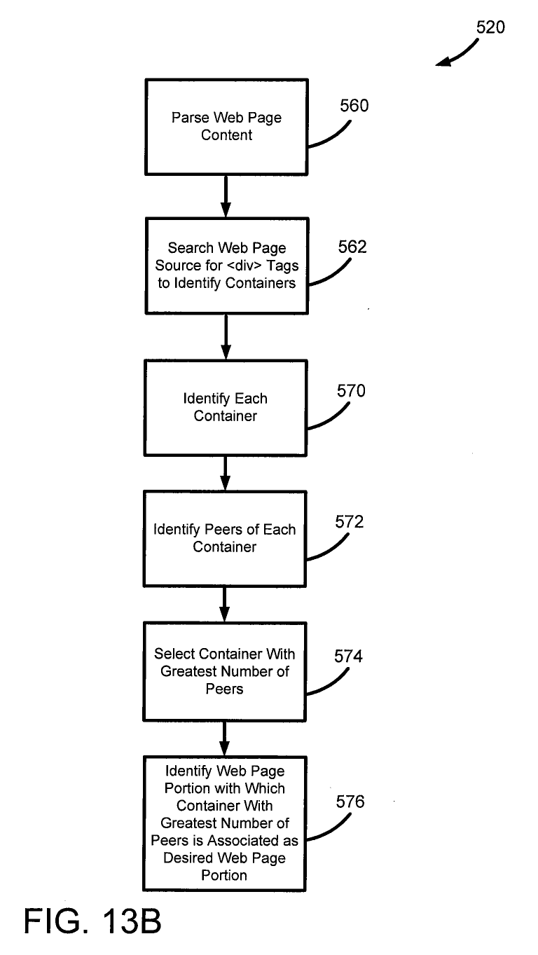

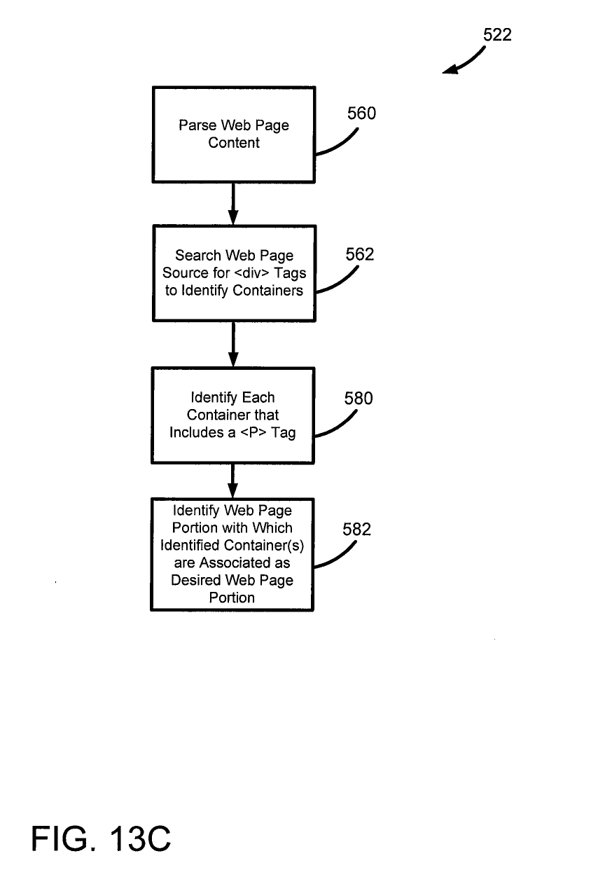

FIGS. 13A and 13B are flow charts of specific implementations of process block 500 for extracting the text of the desired web page portion, in those cases where the desired web page portion is, e.g., a majority text portion. Referring first to FIG. 13A, a specific implementation 518 comprises parsing the web page content (process block 560). Then, the web page source is searched for identifiers of text blocks. According to one approach as in process block 562, the web page source is searched for <div> tags to identify containers. In process block 564, each container that includes a <p> tag is identified. In process block 566, the largest container, by size in memory or bit size, that contains a <p> tag, is determined. In this way, the container with the largest bit size (i.e., highest character or word count) that includes at least some text will be designated. In process block 568, this identified largest container by bit size, as well as all containers of the same type, are designated as the desired web page portion. Following process block 568, the process flow continues to process block 600 of FIG. 9, i.e., the laying out of the extracted text.

In FIG. 13B, an alternative specific implementation 520 also includes parsing the web page content and searching the web page to identify containers (process blocks 560 and 562, respectively). In process block 570, each container of the web page is identified, and in process block 572, each peer of each container is also identified. In process block 574, the container with the greatest number of peer containers is selected. In process block 576, this container with the greatest number of peers is identified as the majority text portion. Following process block 576, the process flow continues to process block 600 of FIG. 9, i.e., the laying out of the extracted text.

In FIG. 13C, an alternative specific implementation 522 also includes parsing the web page content and searching the web page to identify containers (process blocks 560 and 562, respectively). In process block 580, each container of the web page is identified, and each container that includes a <p> tag is identified. In a preferred implementation, <p> tags delimiting text within the cell of a table are ignored. In process block 582, the portion of the web page with every container that includes at least one <p> tag is identified as the majority text portion. Following process block 582, the process flow continues to process block 600 of FIG. 9, i.e., the laying out of the extracted text.

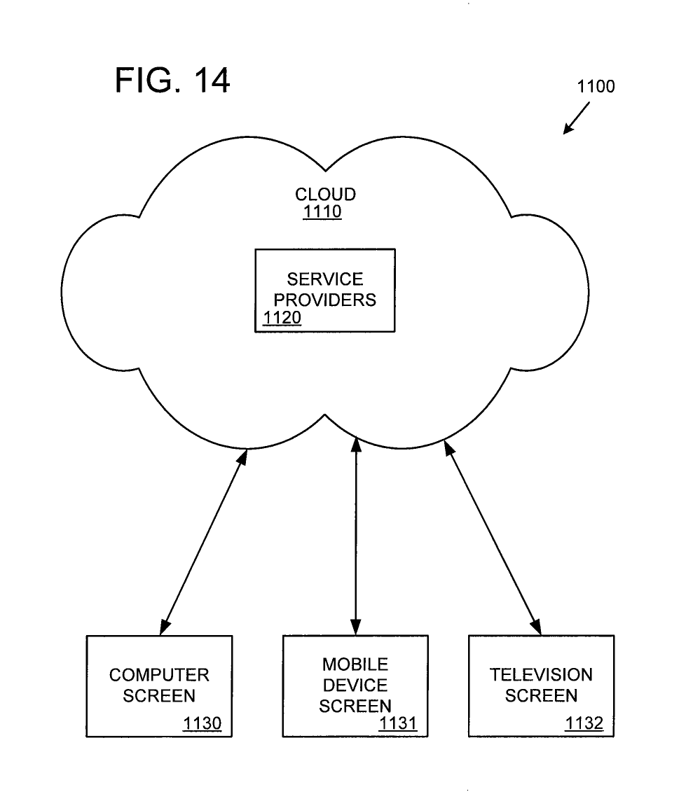

FIG. 14 illustrates a generalized example of a suitable implementation environment 1100 in which described embodiments, methods, techniques, and technologies may be implemented.

In example environment 1100, various types of services (e.g., computing services) are provided by a cloud 1110. For example, the cloud 1110 can comprise a collection of computing devices, which may be located centrally or distributed, that provide cloud-based services to various types of users and devices connected via a network such as the Internet.

In example environment 1100, the cloud 1110 provides services for connected devices 1130-1132 with a variety of screen capabilities. Connected device 1130 represents a device with a computer screen (e.g., a mid-size screen). For example, connected device 1130 could be a personal computer such as desktop computer, laptop, notebook, netbook, or the like. Connected device 1131 represents a device with a mobile device screen (e.g., a small size screen). For example, connected device 1131 could be a mobile phone, smart phone, personal digital assistant, tablet computer, and the like. Connected device 1132 represents a device with a large screen. For example, connected device 1132 could be a television screen (e.g., a smart television) or another device connected to a television (e.g., a set-top box or gaming console) or the like. One or more of the connected devices 1130-1132 can include touch screen capabilities.

Services can be provided by the cloud 1110 through service providers 1120, or through other providers of online services (not depicted). For example, cloud services can be customized to the screen size, display capability, and/or touch screen capability of a particular connected device (e.g., connected devices 1130-1132).

In example environment 1100, the cloud 1110 provides the technologies and solutions described herein to the various connected devices 1130-1132 using, at least in part, the service providers 1120. For example, the service providers 1120 can provide a centralized solution for various cloud-based services (e.g., spelling data, grammar data, word frequency data, etc.). The service providers 1120 can manage service subscriptions for users and/or devices (e.g., for the connected devices 1130-1132 and/or their respective users).

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

1-10. (canceled)

12-20. (canceled)

21. A computer-implemented method for fitting content of a network document onto a reduced-size screen, the method comprising:
displaying the network document on the reduced-size screen;
receiving a user input to indicate a desired portion of the displayed network document;
in response to the user input, extracting content from the desired portion of the network document; and
displaying the extracted content from the desired portion in a manner formatted to fit the reduced-size screen.

22. The computer-implemented method of claim 21, wherein the content extracted from the desired portion of the document and formatted to fit the reduced-size screen is text.

23. The computer-implemented method of claim 21, wherein receiving a user input to indicate a desired portion of the displayed document comprises receiving a signal indicating a contact with a touch-sensitive area of the reduced-size screen.

24. The computer-implemented method of claim 23, further comprising displaying an on-screen menu responsive to the contact.

25. The computer-implemented method of claim 21, wherein receiving a user input comprises receiving a signal to indicate the desired portion of the document is a majority text portion.

26. The computer-implemented method of claim 25, wherein receiving a signal comprises receiving a signal that an on-screen button has been pressed.

27. The computer-implemented method of claim 21, wherein extracting content from the desired portion of the network document includes excluding non-text content from the desired portion.

28. The computer-implemented method of claim 21, wherein displaying the extracted content in a manner formatted to fit the reduced-size screen includes displaying text wrapped to fit the reduced-size screen in lines that are visible without horizontal scrolling.

29. The computer-implemented method of claim 21, further comprising, in response to a user input, zooming the extracted content and reformatting the zoomed content to fit the reduced-size screen.

30. The computer-implemented method of claim 21, further comprising, in response to a user input, terminating display of the extracted text from the desired portion in a fit to screen view and re-displaying a normal view of the network document on the reduced-size screen.

31. The computer-implemented method of claim 21, wherein receiving a user input to indicate a desired portion of the displayed document comprises receiving a signal indicating a contact with a touch-sensitive area for at least a predetermined period of time.

32. The computer-implemented method of claim 21, further comprising determining the current URL of the network document, and comparing the URL to at least one predetermined URL, wherein if the current URL matches the at least one predetermined URL, following a customized approach to identifying the content to be extracted and displayed to fit the reduced-size screen.

33. A computer-implemented method for fitting content of a web page onto a reduced-size screen, the method comprising:
displaying the web page scrollable in two dimensions on the reduced-size screen;
receiving a user input to indicate a desired portion of the displayed web page;
in response to the user input, extracting text from the desired portion of the web page by parsing the web page;
searching the web page source for at least the desired portion of the web page for an identifier indicating a block of text; and
reformatting any block of text in the desired portion of the web page for display as a document scrollable in one dimension.

34. The computer-implemented method of claim 33, wherein searching the web page source for at least the desired portion of the web page for an identifier indicating a block of text includes searching for a <div> tag.

35. The computer-implemented method of claim 33, wherein searching the web page source for at least the desired portion of the web page for an identifier indicating a block of text comprises searching for containers.

36. The computer-implemented method of claim 35, further comprising, for each identified container, identifying at least one peer container of the identified container.

37. The computer-implemented method of claim 35, further comprising, for each identified container, identifying at least one child container of the identified container.

38. The computer-implemented method of claim 33, wherein searching the web page source for at least the desired portion of the web page for an identifier indicating a block of text comprises searching for a largest container.

39. An apparatus for displaying a web page in a graphical user interface for a reduced-size screen, comprising:
a user input element actuatable to designate a desired portion of a web page for viewing in a larger size on the reduced-size screen; and
a fit to screen viewer integrated into a browser and operable to identify at least one text block from the desired portion of the web page and to display the at least one text block formatted to fit the reduced-size screen.

40. The apparatus of claim 39, wherein the reduced-size screen has a touch sensitive portion, and wherein the user input element is a designated area of the touch sensitive portion.
